(19) United States
(12) Patent Application Publication
(10) Pub. No.: US 2012/0028211 A1
(43) Pub. Date: Feb. 2, 2012

(54) OCCLUSION TEMPLATE

(76) Inventor: Ady Palti, Baden-Baden (DE)

(21) Appl. No.: 13/146,993

(22) PCT Filed: Jan. 30, 2009
(86) PCT No.: PCT/EP09/00631

§ 371 Date: Oct. 4, 2011

(51) Int. Cl. A61C 9/00

(52) U.S. Cl. 433/71

(57) ABSTRACT

The invention relates to an occlusion template having position markers comprising prescribed dimensions, applied to prescribed locations of the template, and recognizable as position marks on an image of the jaw or a jaw area of a patient. In order to be able to analyze locally limited X-ray images, the invention proposes that the template comprises more than three position markers, each disposed in the bite area of the template.

The invention relates to an occlusion template with a bite region, which is provided for being held in the oral cavity of a patient and for being bitten by the patient with his/her teeth on a bite surface of this bite region. Such a template comprises a plurality of position markers, which are embodied in three dimensions, respectively have predetermined dimensions, are attached at predetermined points on the template, and can be identified as position markers in an image record of the jaw or jaw region in the patient, which image record was produced whilst biting on the bite region. Furthermore, the invention is directed to applications of such templates.

By way of example, such a template is used by dental technicians, dentists, maxillofacial surgeons, or orthodontists to monitor a tooth or jaw region, which is to be treated with an implant, a dental plate or by an orthodontic, maxillofacial-regulatory, maxillofacial surgical, or surgical method, in respect of its position, orientation, and volume prior to the actual treatment or the actual surgical intervention in order to be able to prepare the treatment or surgery. By way of example, the suitable implant or, in general, the dental plate or orthodontic, regulatory, or surgical treatment can be selected, planned, created, and prepared with the aid of the aforementioned information such as position, orientation, and volume of the tooth or jaw area, which information is more particularly established using image recordings based on an X-ray, computed tomography (CT), volume tomography (VT), magnetic resonance imaging (MRI), or ultrasound method. The known templates have fixed dimensions. Without loss of generality, the invention will be substantially explained in the following text on the basis of the example of tooth implants.

Tooth implants are foreign bodies inserted into the jaw bone. The subfield of dentistry that deals with implanting tooth implants into the jaw bone is referred to as implantology. As a result of their usability as mounts for dentures, tooth implants assume the function of artificial dental roots. A drill template, which is produced using a processing device, is required for placing the dental implants into the jaw.

In the process, the object of the position markers is to form a fixedly prescribed and repeatedly reproducible reference position, from which position, orientation, and volume are possible by means of appropriate distance and size comparisons. To this end, the position markers are embodied such that, firstly, they are visible and measurable in the image, e.g. CT or X-ray image, produced during image recording and, secondly, do not adversely affect the preparation of the dental intervention or the work of the dental technician.

The templates known in the prior art have three position markers, which are arranged at a distance in the bite region of the template. One position marker is typically situated at the front in the center of the incisors and one position marker is in each case situated in the vicinity of a left or right posterior tooth. The relative positions thereof define a fixed coordinate system, on the basis of which the position, orientation, and the volume of the tooth or jaw region may be determined. The position markers in this case form a common plane that is parallel to the plane formed by the template and more particularly to the occlusal plane of the jaw, or is identical thereto. It is for this reason that the template is referred to as an occlusion template or bite template. In maxillofacial surgery, such templates are also referred to as maxillofacial surgical templates.

In the known templates, the position markers are arranged at a great distance from one another. Although this realizes a large measurement basis, this also requires the production of a large-area or large-volume image record in order to capture the position markers in the record, even if in actual fact only a portion of the jaw is of interest. In general, a CT record of the entire head is produced in the process. This results in both a high patient exposure to radiation and higher costs for producing the image. Moreover, the known templates only have one bite surface, and so two CT records with respectively one template, one for the upper jaw and one for the lower jaw, have be recorded in succession, as a result of which the radiation exposure of the patient increases.

In the case of relatively new three-dimensional planning and implantation methods, the image data obtained by means of image records may also be corrected or calibrated, for example in respect of distortion effects, with the aid of the known position of the position markers in order to obtain great accuracy in the overall treatment, for example an implantation or an orthodontic treatment. In the process, the data obtained by means of planning software during the planning of the treatment, for example an implant, may also be directly transmitted to an automatic processing device for precisely carrying out appropriate processing steps on a maxillofacial surgical workpiece, a jaw processing template, a jaw model, or an orthodontic brace, more particularly by drilling, milling, or using a positioning means that serves to guide a maxillofacial surgical tool during bone processing. In the process, there is the problem that the workpiece must be adjusted into the processing device in a zero position that correlates with the position of the occlusion template in the jaw when the image of the occlusion template in the jaw is recorded and correlates with the data obtained therefrom using the occlusion template. That is to say the virtual three-dimensional planning data and coordinates must be transferred accurately to the processing device and the workpiece.

Modern CT scanners also allow the production of smaller, limited image records of a jaw region, for example with image dimensions of 4×6 or 3×3 cm. These small CT records expose the patient to a smaller radiation dose and are more economically effective than conventional ones.

Using this as a starting point, the present invention is based on the object of providing a template that is suitable for maxillofacial surgical or maxillofacial regulatory treatments for example and allows the production of more cost-effective image records connected with a lower radiation exposure.

According to the invention, the object is achieved by an occlusion template with the features of patent claim 1. Preferred embodiments emerge from the dependent patent claims and the following description with associated drawings.

Thus, an occlusion template according to the invention for dental technicians and dentists, more particularly for producing a drill template for teeth implants, comprises a bite region, which is provided for being held in the oral cavity of a patient and for being bitten by the patient with his/her teeth on a bite surface of this bite region, and with a plurality of position markers, which are embodied in three dimensions, respectively have predetermined dimensions, are attached at predetermined points on the template, and can be identified as position markers in an image record of the jaw or jaw region in the patient, which image record was produced whilst biting on the bite region, which template has the characteristic that it has more than three position markers, each of which is arranged in the bite region.

In the case of a correspondingly spatially distributed arrangement of the position markers, this ensures that in each case at least three position markers are situated in the field of view of an image record, more particularly a CT record, even if the latter does not capture the whole jaw but only a diameter of maybe 30 mm to 80 mm.

However, the invention not only has the advantages of making possible image records that are delimited to smaller areas and are associated with lower costs and a reduced radiation exposure, but further embodiments can implement the following additional advantages:
The upper and lower jaw can be recorded at the same time using only a single image record, as a result of which the radiation exposure is further reduced.
The bite situation in the occlusal plane can be molded using a bite compound.
The template can be used to adjust a maxillofacial surgical workpiece in a zero position in a processing device.
The template can serve to adjust or fix the head of the patient in an image recording scanner, e.g. CT or VT, during the recording process of the image record.

The invention will be explained in more detail below on the basis of exemplary embodiments illustrated in the figures. The characteristics described therein may be utilized individually or in combination in order to develop preferred embodiments of the invention. In the figures:

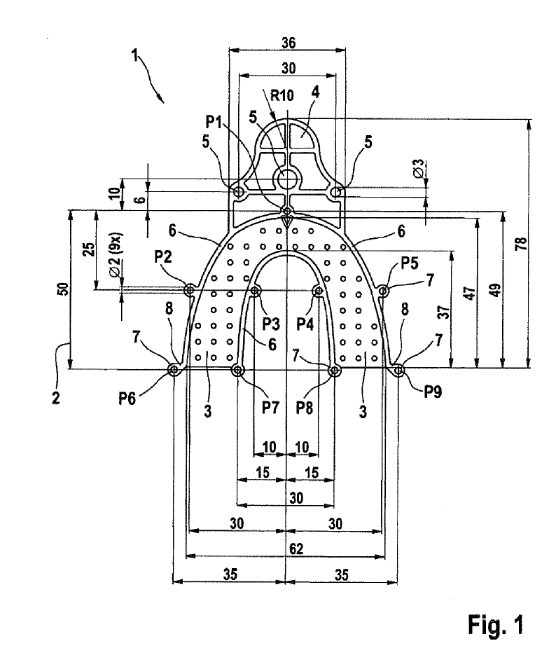

FIG. 1 shows a plan view of a first template according to the invention,

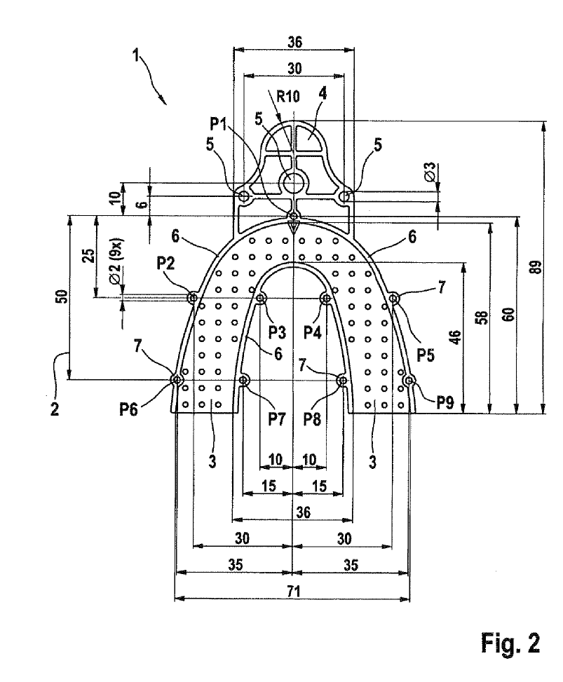

FIG. 2 shows a plan view of a second template according to the invention,

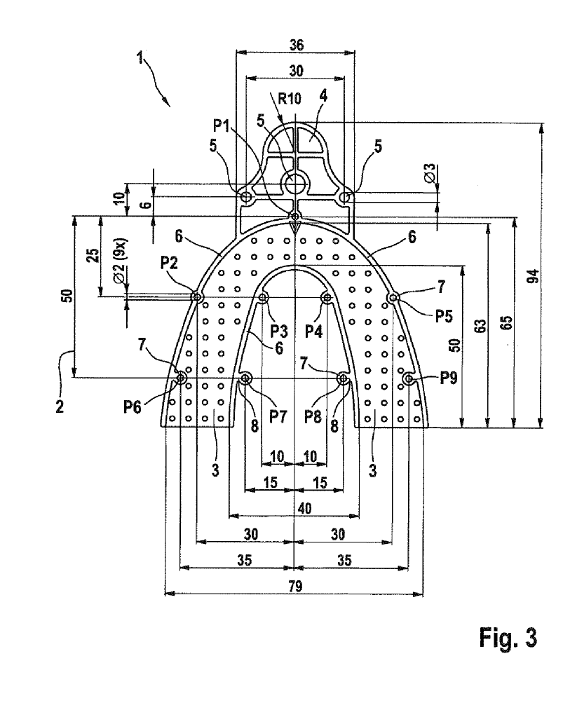

FIG. 3 shows a plan view of a third template according to the invention,

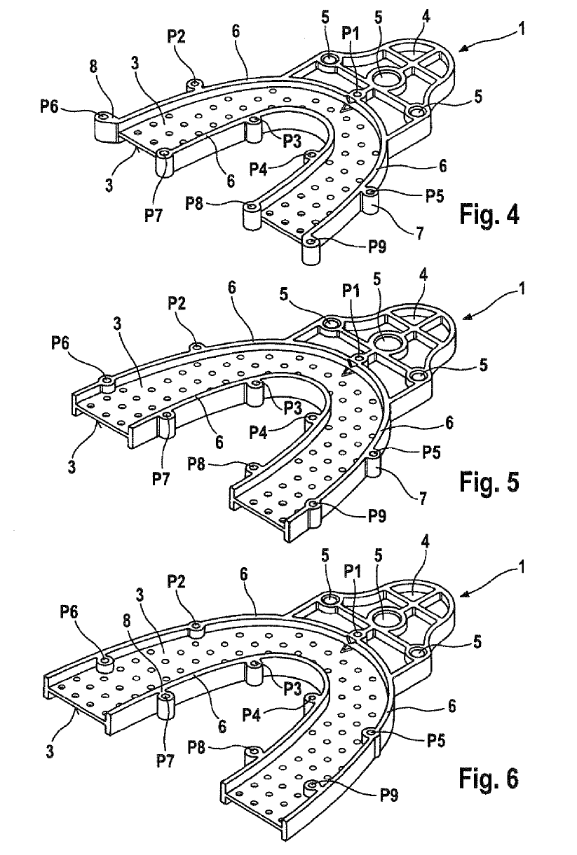

FIG. 4 shows a three-dimensional view in respect of FIG. 1,

FIG. 5 shows a three-dimensional view in respect of FIG. 2, and

FIG. 6 shows a three-dimensional view in respect of FIG. 3.

FIG. 1 shows a plan view of a first template 1 according to the invention. It comprises a bite region 2, which is provided to be held in the oral cavity of a patient and to be bitten by the patient using his/her teeth on a bite surface 3 of this bite region 2. The template 1 has a plurality position markers P, which are embodied in three dimensions; it has a total of 9 position markers P1-P9 in the present exemplary embodiment. The position markers P1-P9 each have predetermined dimensions and are attached to the template 1 at predetermined positions. They consist of a material with a high contrast in X-ray images, such as titanium or ceramic, and so these can be identified as position markers in a record, for example a CT or X-ray record of the jaw or jaw region in the patient, that is produced whilst biting on the bite region 2.

The position markers P1-P9 are each arranged in the bite region 2 of the template 1. The template 1 consists of a material with a low contrast in X-ray images, for example plastic or a material used in production by means of 3D printing. So that the template 1 can be identified more clearly in the record, e.g. a CT or X-ray record, it may contain a component of a barium material, e.g. barium sulfate.

The nine position markers P1-P9 each form triangles that are arranged in the occlusal plane of the jaw. The occlusal plane is predetermined by the bite surface 3 of the template 1, which bite surface preferably has a flat or planar embodiment. In the process, the template 1 preferably has a position marker P1 that is arranged on the axis of symmetry running in the longitudinal direction of the jaw, preferably in the distal region of the template 1 or the bite surface 3.

The position markers P1-P9 advantageously form triangles, the extent of which in the longitudinal direction of the jaw lies between 20 mm and 60 mm, preferably between 30 mm and 40 mm. The extent in the transverse direction of the jaw of the triangles formed by the position markers P1-P9 advantageously lies between 25 mm and 50 mm, preferably between 30 mm and 40 mm. This arrangement ensures that three position markers P are in each case within the field of view of a small, locally delimited image record that is produced, e.g. a CT record. In the figures the respective dimensions are specified in mm.

By way of example, the position markers P1-P9 can be embodied as spheres or as circular cylinders, the longitudinal axes of which are arranged perpendicular to the occlusal plane of the jaw, i.e. perpendicular to the bite surface 3. The diameter of the position markers P1-P9 is advantageously between 1.0 mm and 2.5 mm, preferably between 1.5 mm and 2.1 mm. Artifacts can be generated in the CT records in the case of a larger diameter. The height of the position markers P1-P9 is advantageously between 5.0 mm and 7.0 mm. As a result it is also possible to produce a CT record with a large layer spacing, for example 2 mm.

The position markers P1-P9 preferably protrude over the bite surface 3, preferably all with the same overhang. The position markers P1-P9 have such a geometric arrangement that they are arranged symmetrically with respect to the longitudinal direction of the jaw. The template 1 preferably comprises pairs of position markers P which, in respect of the longitudinal direction of the jaw, are arranged next to the bite surface 3 on both sides in the same longitudinal position or in the edge region of the bite surface 3.

The bite region 2 is preferably arc-shaped. In FIG. 1, the bite surface 3 has an approximate U-shape, wherein one U-limb supports the position markers P2, P3, P6, P7 and the other U-limb supports the position markers P4, P5, P8 and P9. The U-base, which connects the two U-limbs, supports the position marker P1, which is arranged on the axis of symmetry running in the longitudinal direction of the jaw in the distal region of the template 1.

On the U-base there is a projection 4 on the template 1, which projection protrudes out of the oral cavity of the patient who is biting on the template 1. Said projection can serve to position the patient when producing the image record. To this end, the projection 4 can for example be held in a corresponding holding device, be placed on a support, or carry a one- or two-dimensional spirit level. However, the projection 4 may also have one or more assembly reference marks 5, which are attached at a predetermined position on the template 1 and by means of which the template 1 can be clamped in a defined position in a holder corresponding to the assembly reference marks 5, for example for setting a zero position. By way of example, the assembly reference marks 5 can comprise one or more bores, openings, or depressions introduced into the template 1.

At its lateral edges, the bite surface 3 has raised, i.e. protruding over the bite surface 3 in the upward or downward direction, edge webs 6. These edge webs provide the bite surface 3 with a certain amount of rigidity and can prevent the lateral run-off of a biting compound applied to the bite surface 3. Such a casting compound may be arranged on the bite surface 3 for taking a bite impression of the jaw.

Accordingly, the position markers P1-P9 are surrounded by border webs 7, which protrude over the bite surface 3. The border webs 7 can advantageously be formed by the edge webs 6 or be connected to the latter via connection webs 8. The border webs 7 serve to keep the position markers P1-P9 fixedly in their position. The projection 4 also has strengthening webs that are situated at the edge thereof and run across the surface.

FIG. 4 shows a perspective view of the template 1 from FIG. 1. It can be seen that it has two bite surfaces 3, namely an upper bite surface 3 for the upper jaw and a lower bite surface 3 for the lower jaw. Both of these can be provided with a casting compound for taking a bite impression of the jaw. Furthermore, it is also easily possible to see in the figure that the edge webs 6, border webs 7, and connection webs 8 each protrude over the bite surfaces 3 in both the upward and downward direction. This also holds true for the position markers P1-P9 surrounded by the border webs 7, which position markers preferably in each case protrude over the upper and lower bite surface 3 with the same overhang, such that the occlusal plane divides the position markers P1-P9 in half. Accordingly, the edge webs 6 and the border webs 7 also project over both the upper and the lower bite surface 3, preferably with the same overhang.

FIG. 2 shows a template 1, which differs from the template illustrated in FIG. 1 in that the bite surface 3 is designed for a slightly larger jaw by slightly widening the bite surface 3 in the transverse direction, such that the two U-limbs have a slightly greater spacing from one another and are slightly elongated in the longitudinal direction of the jaw, and so the two U-limbs are slightly elongated. However, in terms of absolute coordinates, the position markers P1-P9 and the assembly reference marks 5 are at exactly the same position as in the case of the template in FIG. 1. It is for this reason that the position markers P2, P5, P6 and P9 situated on the outerside of the U-limbs are moved closer to the bite surface 3 and the distance from the position markers P7 and P8 to the inner side of the U-limbs has increased.

A correspondingly further enlarged embodiment of the template 1 is illustrated in FIG. 3, in which the opening width between the U-limbs is further enlarged to fit even larger jaws, and the U-limbs have been elongated to a slightly greater extent. As a result, the position markers P2, P5, P7 and P9 are moved even closer to the bite surface 3, or into the latter, and the distance from the position markers P7 and P8 to the inner side of the U-limbs has increased. FIGS. 5 and 6 show corresponding perspective views of the templates 1 from FIGS. 2 and 3.

The templates 1 illustrated in FIGS. 1 to 3 are part of a set of occlusion templates 1, comprising a plurality, preferably two to four (small, medium, large, and extra-large), preferably three sizes (small, medium, and large) of templates 1, wherein the templates in a set differ in respect of the extent, dimensions, or positions of the bite surfaces 3 in terms of their longitudinal and/or transverse directions, wherein the positions of the position markers P in relation to the position in a jaw are identical in all templates in a set. In the process, provision can advantageously be made for the templates 1 to have a projection that protrudes out of the oral cavity of the patient who is biting on a template, for the projection to have at least one assembly reference mark 5, which is applied at a predetermined position on the template 1 and by means of which the template 1 can be clamped in a defined position into a holder corresponding to the assembly reference mark 5, wherein the positions of the assembly reference marks 5 in relation to the position in a jaw are identical in all templates 1 in a set.

It goes without saying that in addition to one or more standard sizes it is also possible in special cases to produce, for example by means of 3D printing, a specific individual template 1, matched to a patient. This individual template may differ from the standard sizes in respect of the extent, dimensions, or positions of the bite surfaces 3 in the longitudinal and/or transverse directions thereof; however, the positions of the position markers P should correspond to the positions of the position markers P in the standard sizes in order to simplify the evaluation of the image records obtained thereby.

A template 1 according to the invention may for example be used as follows. In the meantime, the technique of replacing a lost tooth by a dental implant and a denture or bridge attached thereto has prevailed. In the process, use is made of an implant (the implant root) that is made of ceramic compound or metal and anchored in the bone; the artificial dental crown is attached thereto. To this end, a bore for the implant root must be introduced into jaw at the site of the lost tooth. Since the artificial dental crown should fit harmoniously into the row of teeth, the implant root should have a diameter that is as large as possible so that it can better absorb the chewing pressure, and the available bone in the jaw is limited, the position and angular orientation of the bore must be determined precisely in advance and must be maintained.

In order to ensure this, it is conventional for a drill template to be created first of all, which has a drill sleeve with a set angular position at the predetermined position and the internal diameter of which corresponds to the diameter of a pilot drill for drilling the jaw. The drill template is worn by the patient while the pilot bore is being drilled. This drill template can be produced using a jaw model of the patient or purely from image records, for example from data obtained by radiographic or computed tomographic means. Furthermore, the information in respect of the extent of the jaw bone required for setting the drill direction are obtained by means of a C image record, for example by means of computed tomography, wherein different slice images through the jaw are possible.

The drill sleeves can be affixed in the drill template by means of an automated processing device after evaluating the image record and the jaw model, wherein inaccuracies should be avoided, which inaccuracies would have to be corrected by expanding the pilot bore in the jaw.

Before tooth implants are inserted, the positions that the implants are to assume in the jaw bone must first of all be set. To this end, an impression is made of the region in the oral cavity that contains the toothless sites and, if need be, the teeth or rows of teeth adjacent thereto. A model is then made from this impression, which model corresponds to that region in the oral cavity into which the implants are to be inserted. The positions of the implants are then fixed on this model. A template, e.g. a drill template, is produced for the model in a next step. Positioning aids are introduced into this template at the implantation sites, which positioning aids serve to guide the surgical tools during the bone processing. The positioning aids generally are sleeves. The sleeves are usually fixed in the template by being cast, polymerized, or screwed in.

However, it is also possible to measure the jaw bone with an inserted template 1 according to the invention, and to transfer the data obtained thereby directly to a drill template using a processing device, without first of all having to make a model of the jaw.

Thus drill templates are aid devices in order to make it easier for the implantologist to introduce a bore into the jaw bone of a patient, into which jaw bone the implant is to be inserted. The drill template has a bore hole, which was produced on the jaw model and serves as a guide for the drill when introducing the bore into the jaw bone. The bore hole should have the correct position and angular position.

The template 1 according to the invention can serve for producing such a drill template for tooth implants or in general for processing a maxillofacial surgical workpiece. In the process, precisely measuring the position of the head of the patient and his/her teeth and the transfer thereof to the workpiece is important for diagnosis and treatment. The position of the occlusal plane of the patient, which can be determined very precisely with a template 1 according to the invention, is very important for some medical methods and dental methods such as implantation, surgery, or orthodontics. The occlusal plane is an approximated, artificial, or imagined plane formed by the intersection between the upper and lower teeth. The position of the occlusal plane can be determined using the template 1 according to the invention in order to determine the position of the teeth with respect to the rest of the head in three dimensions.

In the case of a method for calibrating or correcting an image record of a jaw or jaw region in a patient, who bites on the bite region of a template 1 when the record is produced, a template 1 according to the invention is used during the production of the record and the images of position markers P1-P9 in the record are evaluated for calibrating or correcting the record.

In the case of a method for planning a denture, an implant, or a dental plate or an orthodontic, maxillofacial-regulatory, maxillofacial surgical, or surgical treatment of a tooth, jaw, or jaw region, wherein an image record is produced of a jaw or jaw region in a patient, who bites on the bite region 2 of a template 1 when the record is produced, it is possible that a template 1 according to the invention is used during the production of the record and the images of position markers P1-P9 in the record are evaluated for planning the denture.

In the case of a method for processing a jaw processing template, which serves to process a jaw using a maxillofacial surgical tool, wherein the jaw processing template has a positioning aid, which serves to guide the maxillofacial surgical tool when processing the bone, and wherein an image record is produced of a jaw or jaw region in a patient, who bites on the bite region 2 of a template 1 when the record is produced, it is possible that a template 1 according to the invention is used during the production of the record and the images of position markers P1-P9 in the record are evaluated for planning and/or placing the positioning aid in the jaw processing template or for processing the jaw processing template.

In the case of a method for processing a maxillofacial surgical workpiece, more particularly a jaw processing template, a jaw model, or an orthodontic brace, more particularly by drilling, milling, or using a positioning aid that serves to guide a maxillofacial surgical tool when processing the bone, with a processing device, wherein, for planning the processing, an image record is produced of a jaw or jaw region in a patient, who bites on the bite region 2 of a template 1 when the record is produced, it is possible that a template 1 according to the invention is used during the production of the record and the images of position markers P1-P9 in the record are evaluated for planning and/or controlling the processing of the maxillofacial surgical workpiece.

In the case of a method for positioning a maxillofacial surgical workpiece, more particularly a jaw processing template, a jaw model, or an orthodontic brace, in a processing device for processing a maxillofacial surgical workpiece, more particularly by drilling or milling, comprising the production of an image record of a jaw or jaw region in a patient, who bites on the bite region 2 of a template 1 when the record is produced, and the production of an impression of the jaw or jaw region, it is possible that a template 1 according to the invention is used during the production of the record, the maxillofacial surgical workpiece is aligned in a zero position with respect to the template by means of the impression and a positioning device, and the maxillofacial surgical workpiece is aligned in this zero position for processing in the processing device. Thus, in the process, the coordinates obtained when the record was produced are transferred to the workpiece, i.e. the workpiece is brought into a defined position for processing, which position correlates with the position of the jaw when the record was produced.

Here, it is possible in a first variant that the zero position of the maxillofacial surgical workpiece to be processed with the processing device is aligned in the processing device, wherein the template is clamped into a template holder of the processing device with a predetermined orientation and the workpiece is clamped into an alignable workpiece holder of the processing device, the workpiece holder is aligned with respect to the template holder for setting the zero position of the workpiece and fixed in the zero position, and the workpiece in the zero position is subsequently processed in the processing device.

According to a second variant, it is possible that the zero position of the maxillofacial surgical workpiece to be processed with the processing device is aligned in a positioning device, which is external to the processing device and has a template holder for clamping the template 1 with a predetermined orientation, fixed with respect to the processing device, and also has an alignable workpiece holder for clamping and aligning the workpiece, wherein the workpiece holder is aligned with respect to the template holder for setting the zero position of the workpiece and fixed in the zero position, and the workpiece holder with the workpiece in the zero position is subsequently brought into the processing device for processing the workpiece. To this end, a mechanical or magnetic holder of the workpiece holder may be provided for example in the positioning device and in the processing device.

Such a zero positioning of a bite template 1 is for example carried out as follows. The template 1, embodied as a U-shaped bite fork, with the integrated, for example nine, position markers P1-P9, for example with a length of 6 mm and a diameter of 2 mm, is firstly equipped with a plastic bite material. The template 1 is inserted into the mouth of the patient after applying the bite material. The patient bites into the bite compound and onto the fork base, i.e. the bite surface, with the chewing surfaces of his/her teeth using both the upper and lower jaw, to be precise until the bite material has cured. The result is a bite template 1, which, together with the patient, is sent to an institute in order to produce a three-dimensional image there, for example an X-ray image in the form of a so-called CT-image. During the production of the record, the patient bites onto the template 1 and at least three position markers P, which are situated in the field of view of the instrument utilized during the image recording, for example an X-ray instrument, are captured in the record.

The data record resulting therefrom is stored, for example in the DICOM format, and burnt to CD. As a result of the recorded position markers P and their known positions on the template 1, this data record contains the basis of the calculation for the further planning of the treatment. In terms of the calculation, a surface that divides these position markers P in half in the longitudinal direction needs to be imagined. This is the so-called null plane, from which the calculation of the vectors starts. The position markers P are aligned perpendicularly to the null plane. This makes it possible to calculate every point in this fixed space formed between the position markers P. It is now possible to determine every point that is situated in the record, i.e. to establish the coordinates of said point, by means of an orthogonal-system calculation.

The nine position markers P1-P9 may be subdivided analogously into groups of three. The triangles resulting therefrom are arranged such that they can be acquired in a diagnostically expedient fashion in terms of X-ray in the posterior tooth region and in the anterior tooth region. If a head CT-image is produced, all nine position markers P1-P9 can be seen in the record. If a partial record is produced, which can be recorded using a new generation of equipment, only segments of the jaw can be seen in the X-ray image, which is for example a partial volume record that covers a maximum region of 40 mm. The small triangles in the posterior tooth region and in the anterior tooth region can be captured using this recording technique.

It is now merely one record that is required per patient, even for the simultaneous recording of teeth in the upper jaw and lower jaw. Here the aforementioned calculations may also be carried out, because the triangles have a dimension of 20 mm in one direction and 25 mm in the other direction and thus have a sufficient size to be able to be captured by the recording cone with a 40 mm field of view.

The calculation yields the determination of the six coordinates required for being able to calculate every point in the predetermined space (height 60 mm, diameter 100 mm). These coordinates are used to determine the position of the implants, which have already been planned with the aid of the planning software. The bite template 1 is articulated into the zero position in positioning equipment outside of the processing device with the aid of jaw models produced for example from gypsum. In the process, the jaw model is aligned with respect to the bite template 1 and fixed in the aligned zero position by means of an adjustable and fixable clamping device, which is also referred to as an articulator.

The articulated jaw model, which is articulated into to the zero position in a clamping device with a magnetic holder in the positioning equipment, is transferred into the processing device with the clamping device and serves there to fix the implant drill template placed thereon, which implant drill template has not yet been provided with bores. Now the already calculated coordinates may be used and the points determined for the implantation may be drilled into the drill template by means of the processing device. The guide sleeves are inserted into these bores. The drill template can thereafter be inserted into the jaw of the patient and pilot bores, for the implants, are drilled into the jaw through the guide sleeves by means of a pilot drill.

### LIST OF REFERENCE SIGNS

1 Template
2 Bite region
3 Bite surface
4 Projection
5 Assembly reference mark
6 Edge web
7 Boundary web
8 Connection web
P Position marker
P1-P9 Position markers

1. An occlusion template with a bite region, which is provided for being held in the oral cavity of a patient and for being bitten by the patient with his/her teeth on a bite surface of this bite region, and with a plurality of position markers, which are embodied in three dimensions, respectively have predetermined dimensions, are attached at predetermined points on the template, and can be identified as position markers in an image record of the jaw or jaw region in the patient, which image record was produced whilst biting on the bite region,
characterized in that
the template has more than three position markers, each of which is arranged in the bite region.

2. The template as claimed in claim 1, characterized in that the position markers (P1-P9) each form triangles that are arranged in the occlusal plane of the jaw.

3. The template as claimed in claim 1, characterized in that the position markers form triangles, the extent of which in the longitudinal direction of the jaw lies between 20 mm and 60 mm, preferably between 30 mm and 40 mm.

4. The template as claimed in claim 1, characterized in that the position markers form triangles, the extent of which in the transverse direction of the jaw lies between 25 mm and 50 mm, preferably between 30 mm and 40 mm.

5. The template as claimed in claim 1, characterized in that the position markers are embodied as spheres or as circular cylinders, the longitudinal axes of which are arranged perpendicular to the occlusal plane of the jaw, i.e. perpendicular to the bite surface.

6. The template as claimed in claim 1, characterized in that the diameter of the position markers is between 1.0 and 2.5 mm, preferably between 1.5 and 2.1 mm.

7. The template as claimed in claim 1, characterized in that the height of the position markers is between 5.0 and 7.0 mm.

8. The template as claimed in claim 1, characterized in that the position markers protrude over the bite surface, preferably with the same overhang.

9. The template as claimed in claim 1, characterized in that the position markers are arranged symmetrically with respect to the longitudinal direction of the jaw.

10. The template as claimed in claim 9, characterized in that it has a position marker that is arranged on the axis of symmetry running in the longitudinal direction of the jaw, preferably in the distal region of the template.

11. The template as claimed in claim 1, characterized in that it comprises pairs of position markers which, in respect of the longitudinal direction of the jaw, are arranged next to the bite surface on both sides in the same longitudinal position or in the edge region of the bite surface.

12. The template as claimed in claim 1, characterized in that the bite region is arc-shaped.

13. The template as claimed in claim 1, characterized in that the bite surface is planar.

14. The template as claimed in claim 1, characterized in that the bite surface has raised edge webs at the lateral edges thereof.

15. The template as claimed in claim 14, characterized in that the position markers are surrounded by border webs, which protrude over the bite surface.

16. The template as claimed in claim 15, characterized in that the border webs are formed by the edge webs or are connected to the latter via connection webs.

17. The template as claimed in claim 1, characterized in that it has an upper bite surface for the upper jaw and a lower bite surface for the lower jaw.

18. The template as claimed in claim 17, characterized in that the position markers protrude over both the upper and the lower bite surface, preferably with the same overhang.

19. The template as claimed in claim 14, characterized in that the edge webs protrude over both the upper and the lower bite surface, preferably with the same overhang.

20. The template as claimed in claim 15, characterized in that the border webs protrude over both the upper and the lower bite surface, preferably with the same overhang.

21. The template as claimed in claim 1, characterized in that it has a casting compound on one or two bite surfaces in order to take a bite impression of the jaw.

22. The template as claimed in claim 1, characterized in that it has a projection that protrudes out of the oral cavity of the patient who is biting on the template.

23. The template as claimed in claim 22, characterized in that the projection has at least one assembly reference mark, which is applied at a predetermined position on the template and by means of which the template can be clamped in a defined position into a holder corresponding to the assembly reference mark.

24. The template as claimed in claim 23, characterized in that the assembly reference mark comprises one or more bores, openings, or depressions introduced into the template.

25. A set of occlusion templates, comprising a plurality, preferably two to four, preferably three sizes of templates as claimed in claim 1, characterized in that the templates in a set differ in respect of the extent, dimensions, or positions of the bite surfaces in terms of their longitudinal and/or transverse direction, wherein the positions of the position markers in relation to the position in a jaw are identical in all templates in a set.

26. The set of templates as claimed in claim 25 characterized in that the templates have a projection that protrudes out of the oral cavity of the patient who is biting on a template, the projection has at least one assembly reference mark, which is applied at a predetermined position on the template and by means of which the template can be clamped in a defined position into a holder corresponding to the assembly reference mark, wherein the positions of the assembly reference marks in relation to the position in a jaw are identical in all templates in a set.

27. A method for calibrating or correcting an image record of a jaw or jaw region in a patient, who bites on the bite region of a template when the record is produced, characterized in that a template as claimed in claim 1 is used during the production of the record and the images of position markers in the record are evaluated for calibrating or correcting the record.

28. A method for planning a denture, an implant, or a dental plate or an orthodontic, maxillofacial-regulatory, maxillofacial surgical, or surgical treatment of a tooth, jaw, or jaw region, wherein an image record is produced of a jaw or jaw region in a patient, who bites on the bite region of a template when the record is produced, characterized in that a template as claimed in claim 1 is used during the production of the record and the images of position markers in the record are evaluated for planning the denture.

29. A method for processing a jaw processing template, which serves to process a jaw using a maxillofacial surgical tool, wherein the jaw processing template has a positioning aid, which serves to guide the maxillofacial surgical tool when processing the bone, and wherein an image record is produced of a jaw or jaw region in a patient, who bites on the bite region of a template when the record is produced, characterized in that a template as claimed in claim 1 is used during the production of the record and the images of position markers in the record are evaluated for planning and/or placing the positioning aid in the jaw processing template or for processing the jaw processing template.

30. A method for processing a maxillofacial surgical workpiece, more particularly a jaw processing template, a jaw model, or an orthodontic brace, more particularly by drilling, milling, or using a positioning aid that serves to guide a maxillofacial surgical tool when processing the bone, with a processing device, wherein, for planning the processing, an image record is produced of a jaw or jaw region in a patient, who bites on the bite region of a template when the record is produced, characterized in that a template as claimed in claim 1 is used during the production of the record and the images of position markers in the record are evaluated for planning and/or controlling the processing of the maxillofacial surgical workpiece.

31. A method for positioning a maxillofacial surgical workpiece, more particularly a jaw processing template, a jaw model, or an orthodontic brace, in a processing device for processing a maxillofacial surgical workpiece, more particularly by drilling or milling, comprising the production of an image record of a jaw or jaw region in a patient, who bites on the bite region of a template when the record is produced, and the production of an impression of the jaw or jaw region, characterized in that a template as claimed in claim 1 is used during the production of the record, the maxillofacial surgical workpiece is aligned in a zero position with respect to the template by means of the impression and a positioning device, and the maxillofacial surgical workpiece is aligned in this zero position for processing in the processing device.

32. The method as claimed in claim 31, characterized in that the zero position of the maxillofacial surgical workpiece to be processed with the processing device is aligned in the processing device, wherein the template is clamped into a template holder of the processing device with a predetermined orientation and the workpiece is clamped into an alignable workpiece holder of the processing device, the workpiece holder is aligned with respect to the template holder for setting the zero position of the workpiece and fixed in the zero position, and the workpiece in the zero position is subsequently processed in the processing device.

33. The method as claimed in claim 31, characterized in that the zero position of the maxillofacial surgical workpiece to be processed with the processing device is aligned in a positioning device, which is external to the processing device and has a template holder for clamping the template with a predetermined orientation, fixed with respect to the processing device, and also has an alignable workpiece holder for clamping and aligning the workpiece, wherein the workpiece holder is aligned with respect to the template holder for setting the zero position of the workpiece and fixed in the zero position, and the workpiece holder with the workpiece in the zero position is subsequently brought into the processing device for processing the workpiece.
